(19) United States
(12) Patent Application Publication
(10) Pub. No.: US 2013/0247589 A1
(43) Pub. Date: Sep. 26, 2013

(54) POSITION MEASURING SYSTEM AND METHOD

(71) Applicant: SAMSUNG ELECTRONICS CO., LTD., Suwon-si (KR)

(72) Inventors: In Ho SEO, Daejeon (KR); Jin Sung KNO, Seoul (KR); Jae Chol JOO, Suwon-si (KR); Yong Ho CHOI, Hwaseong-si (KR); Seung Min CHOI, Suwon-si (KR); Chang Hoon CHOI, Suwon-si (KR)

(73) Assignee: SAMSUNG ELECTRONICS CO., LTD., Suwon-Si (KR)

(21) Appl. No.: 13/848,831

(22) Filed: Mar. 22, 2013

(30) Foreign Application Priority Data
Mar. 23, 2012 (KR) 10-2012-0029917

(51) Int. Cl. G01B 9/02; F25B 21/02

(52) U.S. Cl. CPC G01B 9/02075; F25B 21/02
USPC 62/3.2

(57) ABSTRACT

A position measurement device includes a light source, a reflector coupled to a test object, a light detector between the light source and reflector, and a controller to measure a position of the test object based on an interference pattern generated by a reference beam and a measurement beam output from the light detector. The controller also controls a temperature of the light detector by generating signals for a heat exchanger having a Peltier region coupled to the light detector. The signals including a first signal to cause the heat exchanger to remove heat from the light receiver and a second signal to cause the heat exchanger to apply heat to the light receiver.

### CROSS-REFERENCE TO RELATED APPLICATION

This application claims the benefit of Korean Patent Applications No. 2012-0029917, filed on Mar. 23, 2012 in the Korean Intellectual Property Office, the disclosure of which is incorporated herein by reference.

### BACKGROUND

1. Field

The present disclosure relates to measuring the position of an object

2. Description of the Related Art

Position measuring is used in various technology areas including semiconductor device fabrication where nano-scale displacement measurement of a stage is to align a mask and wafer. Some examples of measurement equipment which have been used to obtain position measurements on the nano-scale include Atomic Force Microscopy (AFM) or a Scanning Near-field Optical Microscopy (SNOM).

Another type of position measuring device is an interferometer. Interferometers have been used in various fields requiring micro displacement measurement, such as, for example, optical device processing, diamond grinding, precision machinery processing, and precision measurement. As a specific example, laser interferometers have been used to acquire information related to an object to be measured, by analyzing interference patterns generated by reference and measurement beams.

One type of laser interferometer includes a laser device and a detector head. The detector head may include an optical unit consisting of a beam splitter and a stationary mirror, a moving mirror, and a detector, for example.

In operation, the detector head splits a laser beam, emitted from the laser device, using the beam splitter of the optical unit. Among split laser beams, the detector head combines a reference laser beam reflected from the stationary mirror with a measurement laser beam reflected from the moving mirror that is located on an object to be measured, and directs the combined laser beam to the detector, thereby measuring a displacement of the object to be measured.

More specifically, the aforementioned type of laser interferometer splits a laser beam emitted from the laser device into a reference laser beam having a fixed length optical path and a measurement laser beam that moves based on movement of the object to be measured and that has a variable length optical path. The displacement of the object is measured based on an interference pattern defined by the reference laser beam and the measurement laser beam.

In the case of a system for position measurement and control using the aforementioned laser interferometer, measurement errors due to temperature changes may occur. In this case, temperature measurement errors may generally be classified into three types of error: firstly, measurement error due to change of an index of refraction depending on temperature; secondly, measurement error due to expansion of an object to be measured depending on temperature; and thirdly, measurement error due to expansion of the optical unit of the detector head included in the laser interferometer depending on temperature.

As devices get smaller, detecting and correcting position measurement errors (especially in the nano-scale range) caused by temperature variations and/or other factors is desirable. For example, among the aforementioned errors, measurement error due to expansion of the optical unit of the detector head depending on temperature may be 50 nm/° C. Therefore, systems for nano-scale precision measurement may require temperature compensation.

For this reason, companies that provide laser interferometers have provided temperature compensation devices in an attempt to provide some level of temperature compensation. However, these devices have proven inadequate, e.g., these temperature compensation devices attempt to manage the temperature of the entire system. However, controlling a temperature of the entire system rather than a temperature of the optical unit of the detector head or one or more other constituent components may still cause errors, despite a precise temperature control resolution up to 0.1° C. Accordingly, enhancement in measurement precision is restricted.

### SUMMARY

Example embodiments disclosed herein provide a position measurement device which may reduce measurement errors due to temperature change of a detector head included in a laser interferometer, thereby achieving highly precise measurements of a displacement of an object to be measured.

In accordance with an example embodiment, a laser interferometer includes a laser device to emit a laser beam, a detector head to receive the laser beam emitted from the laser device, and a controller to control compensation for a temperature of the detector head such that the temperature of the detector head reaches a target temperature, wherein the detector head includes an optical unit which splits the laser beam, emitted from the laser device, into a reference laser beam and a measurement laser beam to cause the measurement laser beam to penetrate an object to be measured, and which defines an interference pattern due to a difference between optical paths of the measurement laser beam reflected from the object to be measured and the reference laser beam, a temperature sensing unit which senses the temperature of the detector head, and a temperature compensation unit which compensates for the temperature of the detector head in response to a control signal of the controller.

The detector head may include a detecting unit to detect the interference pattern defined by the optical unit, and the controller may calculate a displacement of the object to be measured based on the detected interference pattern after performing temperature compensation for the detector head. The temperature compensation unit may include a Peltier element.

The temperature compensation unit may include a heat sink attached to a heat emission region of the Peltier element and a cold sink provided on a heat absorption region of the Peltier element. The cold sink may be provided around the optical unit to surround the optical unit.

The optical unit may include a beam splitter which splits the laser beam, emitted from the laser device, into the reference laser beam and the measurement laser beam to cause the split measurement laser beam to penetrate the object to be measured, and which receives the beam reflected from the displaced object to be measured and reflects the split reference laser beam, and a stationary mirror which directs the reflected reference laser beam to the beam splitter to allow the interference pattern to be defined due to a difference between the optical paths of the measurement laser beam from the beam splitter and the reference laser beam.

In accordance with another example embodiment, a displacement measurement system using a laser interferometer, includes a vacuum chamber, an XY stage provided in the vacuum chamber, a moving mirror provided on the XY stage, a laser device to emit a laser beam, a detector head provided on a wall surface of the vacuum chamber at a position corresponding to the moving mirror, the detector head being adapted to receive the laser beam emitted from the laser device, and a controller to control compensation for a temperature of the detector head such that the temperature of the detector head reaches a target temperature, wherein the detector head includes an optical unit which splits the laser beam, emitted from the laser device, into a reference laser beam and a measurement laser beam to cause the measurement laser beam to penetrate the moving mirror, and which defines an interference pattern due to a difference between optical paths of the measurement laser beam reflected from the moving mirror and the reference laser beam, a temperature sensing unit that senses the temperature of the detector head, and a temperature compensation unit that compensates for the temperature of the detector head in response to a control signal of the controller.

The detector head may include a detecting unit to detect the interference pattern defined by the optical unit, and the controller may calculate a displacement of the XY stage based on the detected interference pattern after performing compensation for the temperature of the detector head. The temperature compensation unit may include a Peltier element.

The temperature compensation unit may include a heat sink attached to a heat emission region of the Peltier element and a cold sink provided on a heat absorption region of the Peltier element. The cold sink may be provided around the optical unit to surround the optical unit.

The optical unit may include a beam splitter which splits the laser beam, emitted from the laser device, into the reference laser beam and the measurement laser beam to cause the split measurement laser beam to penetrate an object to be measured, and which receives the beam reflected from the displaced object to be measured and reflects the split reference laser beam, and a stationary mirror which directs the reflected reference laser beam to the beam splitter to allow the interference pattern to be defined due to a difference between the optical paths of the measurement laser beam from the beam splitter and the reference laser beam.

In accordance with another example embodiment, a laser interferometer includes a laser device to emit a laser beam, a detector head, wherein the detector head includes: an optical unit which splits the laser beam, emitted from the laser device, into a reference laser beam and a measurement laser beam to cause the measurement laser beam to penetrate an object to be measured, and which defines an interference pattern due to a difference between optical paths of the measurement laser beam reflected from the object to be measured and the reference laser beam; a detecting unit which detects the interference pattern defined by the optical unit; a temperature sensing unit which senses a temperature of the optical unit; and a temperature compensation unit which compensates for the temperature of the optical unit, and a controller to control compensation for the temperature of the optical unit of the detector head such that the temperature of the optical unit of the detector head reaches a target temperature, and to control calculation of a displacement of the object to be measured based on the detected interference pattern after performing compensation for the temperature of the optical unit.

The temperature compensation unit may include a Peltier element, a heat sink attached to a heat emission region of the Peltier element, and a cold sink provided on a heat absorption region of the Peltier element. The cold sink may be provided around the optical unit to surround the optical unit.

In accordance with one embodiment, a temperature control device includes a signal line to receive a signal indicative of a temperature of a light receiver and a controller to control a temperature of the light receiver based on a signal from the sensor. The controller generates signals for controlling a heat exchanger having a Peltier region coupled to the light receiver. The signals include a first signal to cause the heat exchanger to remove heat from the light receiver and a second signal to cause the heat exchanger to apply heat to the light receiver.

The first control signal causes a control current to flow in a first direction to cause the Peltier region to operate in a manner which causes heat to be removed from the light receiver, and the second control signal causes the control current to flow in a second direction to cause the Peltier region to operate in a manner which causes heat to be applied to the light receiver.

When the temperature detected by the sensor is above a reference temperature, the controller is configured to generate the first signal to cause the heat exchanger to remove heat from the light receiver. When the temperature detected by the sensor is below a reference temperature, the controller is configured to generate the second signal to cause the heat exchanger to apply heat to the light receiver.

Additionally, the controller may set a magnitude of the first signal or the second signal based on the temperature detected by the sensor. The magnitude of the first signal or the second signal, or both, may correspond to a temperature change of the light receiver to be performed by the heat exchanger.

In accordance with another embodiment, an optical device includes a light receiver configured to receive light and a heat exchanger coupled to the light receiver and including a Peltier region between a cold sink and a heat sink. The Peltier region receives a first control signal to cause heat to be removed from the light receiver and a second control signal to cause heat to be applied to the light receiver. The first control signal causes a temperature of the light receiver to fall within a temperature range, and the second control signal causes the temperature of the light receiver raise to within the temperature range.

The device may further include a sensor to detect a temperature of a light receiver, wherein the Peltier region receives the first and second control signals based on the temperature detected by the sensor. The Peltier region may be in direct contact with the cold sink and the heat sink or may otherwise be thermally coupled to the heat and cold sinks. The cold sink at least partially surrounds the light receiver and the heat sink is adjacent the cold sink.

In accordance with another embodiment, a measurement device includes a light source, a reflector coupled to a test object, a light detector between the light source and reflector, and a controller to measure a position of the test object based on an interference pattern generated by a reference beam and a measurement beam output from the light detector, the measurement beam traveling along an optical path that includes the reflector The controller also controls a temperature of the light detector by generating signals for a heat exchanger having a Peltier region coupled to the light detector.

The signals include a first signal to cause the heat exchanger to remove heat from the light receiver and a second signal to cause the heat exchanger to apply heat to the light receiver. The first control signal causes a control current to flow in a first direction to cause the Peltier region to operate in a manner which causes heat to be removed from the light receiver, and the second control signal causes the control current to flow in a second direction to cause the Peltier region to operate in a manner which causes heat to be applied to the light receiver.

The device further includes a sensor configured to detect a temperature of the light detector, wherein the controller is configured to generate the first signal when the temperature detected by the sensor is above a reference temperature and is configured to generate the second signal when the signal is below the reference temperature.

The controller may also set a magnitude of the first signal or the second signal based on the temperature detected by the sensor. The magnitude of the first signal or the second signal corresponds to temperature change of the light receiver to be performed by the heat exchanger.

The heat exchanger may include a cold sink at least partially around the light detector, and a heat sink is adjacent the cold sink, wherein the Peltier region is between the heat sink and the cold sink. The test object may be a stage supporting a semiconductor wafer, and at least the reflector and the light detector may be located in a vacuum chamber.

Also, the light detector may include a beam splitter through which passes the reference beam, the measurement beam, and a beam from the light source; and a reflector to receive the reference beam from the beam splitter and to reflect the reference beam back to the beam splitter.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 shows an example embodiment of position measurement device.

FIG. 2 shows an example of a temperature compensator.

FIG. 3 shows an example of detector head.

FIG. 4 shows a cross-sectional view of the detector head.

FIG. 5 shows an example of a position measurement system.

FIG. 6 shows another example of a position measurement system.

### DETAILED DESCRIPTION OF EXAMPLE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments are shown by way of example in the drawings and will be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (eg., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

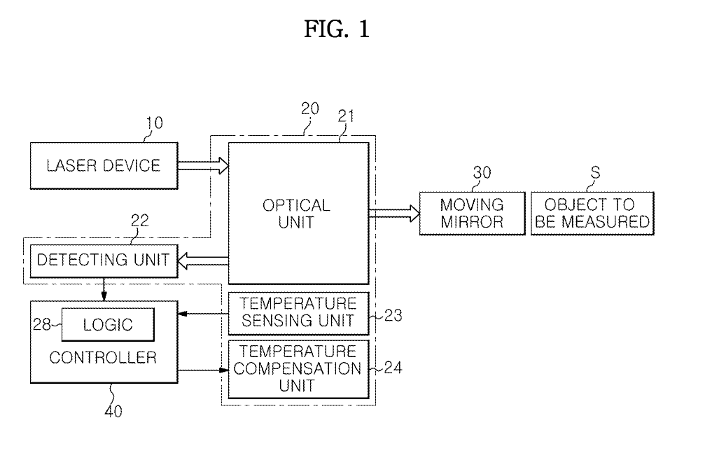

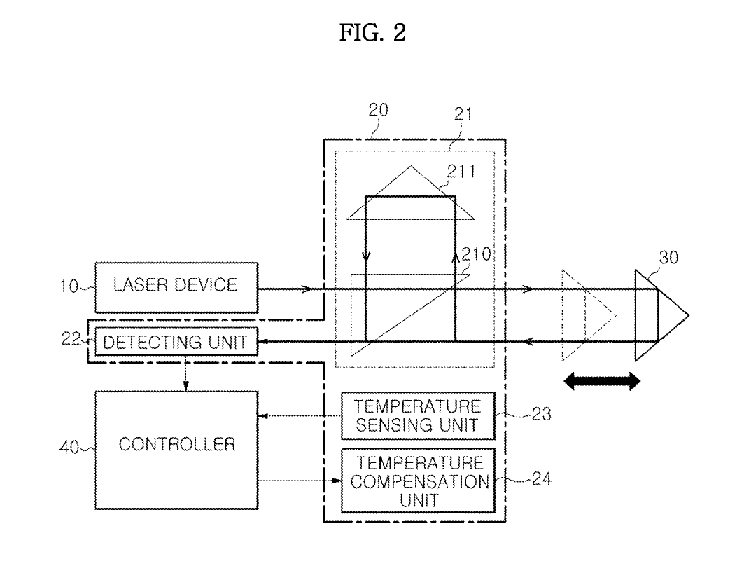

FIGS. 1 and 2 show one embodiment a laser interferometer including a laser device 10, a detector head 20, a moving mirror 30, and a controller 40. The laser device 10 emits a laser beam of a predetermined wavelength to the detector head 20. The detector head 20 includes an optical unit 21, a detecting unit 22, a temperature sensing unit 23, and a temperature compensation unit 24.

The optical unit 21 includes a beam splitter 210 and a stationary mirror 211. The optical unit 21 is installed on a radiation path of the laser beam emitted from the laser device 10, and splits the laser beam emitted from the laser device 10 into two directional beams. More specifically, the beam splitter 210 splits the laser beam into a first directional beam orthogonal to a laser beam radiation direction and a second directional beam in the laser beam radiation direction.

The split beams correspond to a reference laser beam having a fixed length optical path and a measurement laser beam that moves through (or is reflected from) an object to be measured S. Unlike the reference laser beam, the measurement laser beam has a variable-length optical path. The reference and measurement beams produce an interference pattern, when combined, as a result of the difference in the optical path lengths of the two beams.

The stationary mirror 211 is kept stationary on a radiation path of the first directional laser beam split by the beam splitter 210, and reflects the first directional laser beam (in a direction orthogonal to the laser beam radiation direction) from the beam splitter 210.

The moving mirror 30 is provided at one side of the object to be measured S and reflects the second directional laser beam (in the laser beam irradiation direction) split by the beam splitter 210.

Accordingly, the laser beam emitted from the laser device 10 is split into a reference laser beam and a measurement laser beam by the beam splitter 210 such that the reference laser beam is directed in a direction orthogonal to the laser beam irradiation direction and the measurement laser beam is directed in the laser beam irradiation direction as shown, for example, in FIG. 2.

The reference laser beam is reflected from the stationary mirror 211 and then is repeatedly reflected by the beam splitter 210. The measurement laser beam is reflected from the moving mirror 30 and penetrates the beam splitter 11. The reference laser beam, which has sequentially been reflected by the stationary mirror 211 and the beam splitter 210, and the measurement laser beam, which has been reflected by the moving mirror 30 and has penetrated the beam splitter 210, are introduced to the detecting unit 22.

The detecting unit 22 receives the reference laser beam reflected from the stationary mirror 211 and the measurement laser beam reflected from the moving mirror 30 and detects an interference pattern defined based on a difference between optical paths of the reference laser beam and measurement laser beam.

As indicated, the reference laser beam has a fixed length optical path and the measurement laser beam traverses a variable path based on movement of the mirror/test object. The reference laser beam and measurement laser beam therefore have different optical paths and combine to form an interference pattern.

The controller 40 measures displacement relative to an initial position of the object to be measured S based on the interference pattern detected by the detecting unit 22. In this case, a change intensity of the interference pattern detected by the detecting unit 22 is caused by a phase difference between the reference laser beam and the measurement laser beam.

For example, the controller 40 may calculate the phase difference between the reference laser beam and the measurement laser beam by measuring the number of movements of the interference pattern, to thereby calculating a displacement relative to the initial position of the object to be measured S.

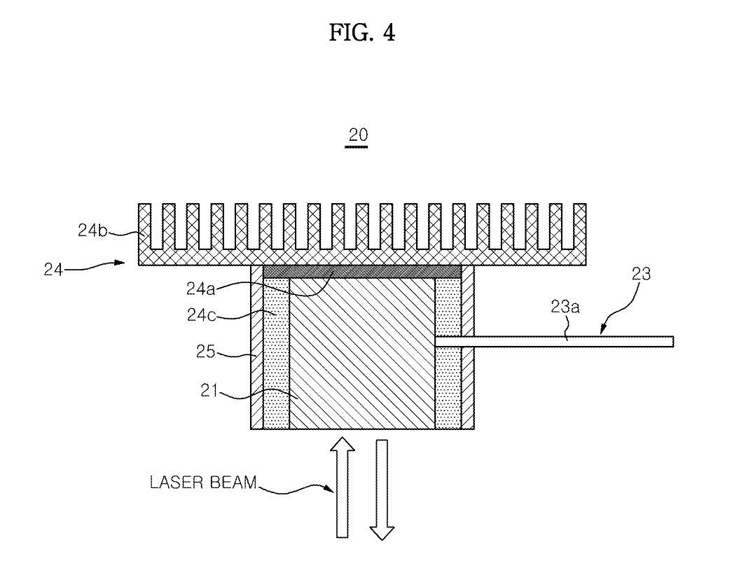

The temperature sensing unit 23 senses a temperature of the detector head 20. In one embodiment, the temperature sensing unit 23 may sense a temperature of the optical unit 21 of the detector head. The temperature sensing unit 23 includes a temperature sensor 23a as shown, for example, in FIG. 4.

The temperature sensing unit inputs a signal indicative of temperature of the detector head, or of a portion of the detector head (e.g., optical unit 21) into the controller 40, and logic of the controller may receive the temperature signal. When the operations of the controller are implemented in software, firmware, or other set of instructions or code, the logic may constitute one section of the code. Additionally, or alternatively, the logic may correspond to a signal line 28, which may be included in the controller and/or may be external to the controller or may be a port or other input of the controller for receiving the temperature signal.

The temperature compensation unit 24 compensates for a temperature of detector head 20 by increasing or decreasing the temperature. In one embodiment, the temperature compensation unit 24 may compensate for a temperature of the optical unit 21 of the detector head. Also, in one embodiment, the temperature compensation unit 24 may include a Peltier element. A Peltier element is an element using the Peltier effect in which heat emission or heat absorption occurs when current is applied to different metallic contact surfaces.

In the Peltier element, a heat transfer direction is determined based on a current movement direction. A movement direction of current to a thermoelectric module when a present temperature of the detector head 20 is less than a target temperature is opposite to a movement direction of current to a thermoelectric module when the present temperature of the detector head 20 is greater than the target temperature. (The direction of current in the former case may be referred to as a forward direction, and the direction of current in the latter case may be referred to as a backward direction). The direction and quantity of current applied to the Peltier element may be controlled by the controller 40.

The controller 40 calculates a difference between a current temperature of detector head 20 sensed by the temperature sensing unit 23 and a target temperature. That is, the controller 40 subtracts the target temperature from the current temperature. If a temperature difference value has a negative sign, the current temperature is lower than the target temperature. In this situation, the controller 40 controls the temperature compensation unit 24 to perform heat emission in order to raise the temperature of the detector head to the target temperature.

On the other hand, if the temperature difference value has a positive sign, the current temperature is greater than the target temperature and controller 40 controls the temperature compensation unit 24 to perform heat absorption in order to lower the temperature of the detector head to the target temperature.

Assuming that a direction of control current during heat emission is referred to as a forward direction and a direction of control current during heat absorption is referred to as a backward direction, the direction of control current is determined based on the positive or negative sign of the temperature difference value.

The controller 40 may also determine a quantity (e.g., magnitude) of control current to be applied to the temperature compensation unit 24. In one embodiment, the quantity is determined based on an absolute value of the temperature difference value and the movement of the determined quantity of control current to the temperature compensation unit 24 may be controlled.

The temperature compensation unit 24 may then perform heat emission or heat absorption to increase or decrease the absolute value of the temperature difference value. In this case, for example, assuming that the temperature difference value falls within a certain range (e.g., 5° C.), a proportional quantity (e.g., magnitude) of control current may be required to effect heat emission to raise the temperature by a commensurate amount (e.g., 5° C.) or to effect heat absorption to lower the temperature by a commensurate amount (e.g., 5° C.), whichever case is applicable.

Additionally, or alternatively, the timing of the current may be controlled to effect temperature changes. For example, control current may be applied for a time sufficient to lower or raise the temperature of the optical unit to a desired value.

In one embodiment, the heat emission or heat absorption may be performed to set to the temperature to an amount that does not necessarily equal the temperature different value but which reduces the temperature difference value to within a predetermined or desired range. In this or another embodiment, the temperature may be raised or lowered to set the temperature difference value to within a given tolerance.

Because a difference between heat emission and heat absorption is associated with a direction of control current and a quantity of control current is associated with a degree of heat emission or heat absorption, information indicative of a quantity of control current calculated based on an absolute value of the temperature difference value may be input into temperature compensation unit 24.

After compensating for the temperature of the detector head 20 via the temperature compensation unit 24, the controller 40 calculates a displacement of the object to be measured S based on the interference pattern detected via the detecting unit 22.

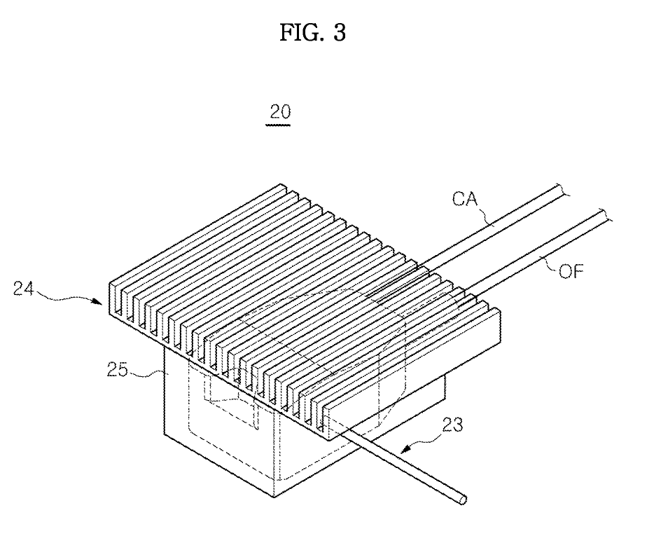

FIG. 3 shows an example of a detector head that may be included in the laser interferometer, and FIG. 4 shows a cross-sectional view of this head. In these figures, detector head 20 is shown to include a head body 25 and the optical unit 21, temperature sensing unit 23 and temperature compensation unit 24 are coupled to the head body 25. Also, the temperature sensing unit 23 includes temperature sensor 23a.

The temperature compensation unit 24 includes Peltier element 24a, a heat sink 24b, and a cold sink 24c. The Peltier element 24a may be constructed, for example, by coupling two different metals or by bonding together an N-type semiconductor and a P-type semiconductor. The Peltier element 24a may perform heat emission and heat absorption at both metal surfaces upon receiving direct current. Additionally, the Peltier element 24a may include a plate having a constant thickness. Moreover, the Peltier element 24a may be thermally coupled to heat sink 24b and optical unit 21. In one embodiment, the Peltier element contacts heat sink 24b and optical unit 21 using a thermo-conductive adhesive. Alternatively, the Peltier element may contact heat sink 24b and optical unit 21 via screw-fastening arrangement between head body 25 and heat sink 24b.

The optical unit 21 may be located on a heat absorption region (e.g., rear surface) of the Peltier element 24a. As such, a temperature of the optical unit 21 may be lowered to a target temperature range by heat absorption of the Peltier element 24a.

The heat sink 24b may be placed on a front surface of the Peltier element 24a when functioning as a heat emission region. A fan or water-cooling device or natural convection may be used, for example, to cool the heat sink 24b.

The cold sink 24c may be placed on a rear surface of the Peltier element 24a when functioning as the heat absorption region. The cold sink 24c may be located partially or entirely around the optical unit 21 within head body 25, and the detecting unit 22 may be located within the optical unit 21.

The heat sink 24b and the cold sink 24c may be formed of a highly thermally conductive material, such as aluminum, to ensure efficient heat exchange using thermal conduction with the Peltier element 24a.

For example, if forward current is applied to the Peltier element 24a of the temperature compensation unit 24 having the aforementioned configuration, the cold sink 24c is cooled by heat absorption on the rear surface of the Peltier element 24, which may lower a temperature of the optical unit 21 surrounded by the cold sink 24c. As such, it may be possible to reduce measurement error due to expansion of the detector head 20 depending on temperature in the laser interferometer, which may result in higher displacement measurement precision of the object to be measured S.

Supply of current to the Peltier element 24a may be shut off if the temperature of the detector head 20 sensed by the temperature sensor 23a reaches or comes within a predetermined range of a target temperature. In this case, heat collected in the heat sink 24b may be removed, for example, by natural convection or forced convection of air. Alternatively, the Peltier element 24a may be controlled to perform heat emission on its front surface, raising the temperature of the heat sink. Cooling of the heat sink may take place by natural or forced convection.

If the temperature of the detector head is sensed to be too low, current to the Peltier element 24a may be applied in a reverse direction to perform a heat emission operation to raise the temperature of the detector head back to the target temperature.

Meanwhile, the detector head 20 and laser device 10 are connected to each other through an optical fiber OF. The detector head 20 receives the laser beam from the laser device 10 through the optical fiber OF.

The controller 40 and detector head 20 may be connected to each other via a cable CA. The controller 40 receives a signal related to the interference pattern detected by the detecting unit 22 of the detector head 20 through the cable CA. The controller 40 may also receive a signal related to the temperature sensed by the temperature sensing unit 23 and transmit a control signal for temperature compensation to the temperature compensation unit 24 through the cable CA.

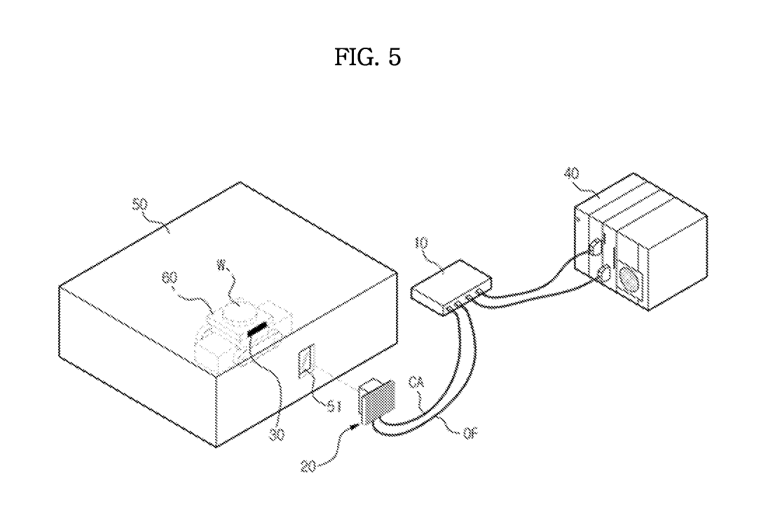

FIG. 5 shows an embodiment of a system for measuring displacement using a laser interferometer. This system includes laser device 10, detector head 20, moving mirror 30, controller 40, a vacuum chamber 50, and an XY stage 60. The XY stage 60 is a stage on which a semiconductor wafer W is placed and is installed below the vacuum chamber 50. The XY stage 60 is moved in an X-direction and a Y-direction by a drive device that drives the XY stage 60. For example, the drive device moves the XY stage 60 such that a portion of the semiconductor wafer W, on which recognition signs and a circuit pattern are formed, is located at a preset position.

The moving mirror 30 of the laser interferometer is placed on the XY stage 60 to measure a displacement of the XY stage during movement of the XY stage. Accordingly, moving mirror 30 is moved whenever the XY stage 60 is moved.

A transparent window 51 is formed at a position of a wall of the vacuum chamber 50 corresponding to the moving mirror 30 placed on the XY stage 60. The interior of the vacuum chamber 50 is visible through the transparent window 51.

The detector head 20 is placed near the window 51 and directs a laser beam to the moving mirror 30 and receives the laser beam reflected from the moving mirror 30. The detector head 20, as described above, may include the optical unit 21, detecting unit 22, temperature sensing unit 23, and temperature compensation unit 24 (see FIGS. 3 and 4).

The detector head 20 receives the laser beam from the laser device 10 and splits the laser beam into a reference laser beam and a measurement laser beam. The detector head 20 receives the reference laser beam having passed through the stationary mirror and the measurement laser beam having passed through the moving mirror 30 placed on the XY stage 60. Thereby, the detector head 20 detects an interference pattern between the reference laser beam and the measurement laser beam.

The controller 40 measures a displacement relative to an initial position of the XY stage 60 based on the interference pattern detected by the detecting unit 22. The controller 40 measures a displacement relative to an initial position of the object to be measured S. In this case, the controller 40 may calculate a displacement relative to an initial position of the XY stage 60 by calculating a phase difference between the reference laser beam and the measurement laser beam.

To reduce measurement error due to expansion of the detector head 20 (more particularly, the optical unit 21) causes by temperature changes when measuring displacement relative to an initial position of the XY stage 60, the controller 40 senses a temperature of the detector head 20 via the temperature sensing unit 23 and compensates for the temperature of the detector head 20 via the temperature compensation unit 24 based on the sensed temperature.

Fluctuations in temperature may cause the index of refraction of one or more optical components of the system to change, may cause expansion of an object (e.g., wafer stage) to be measured to occur, and/or may cause expansion of one or more elements of the optical unit of the laser interferometer to occur. These effects may, in turn, translate into displacement or measurement errors that may be detected and compensated for by the temperature compensation unit as previously described.

Moreover, in the displacement measurement system using a laser interferometer as previously described, a laser beam may be transmitted from the detector head 20 to the moving mirror 30 through vacuum of vacuum chamber 50. This may further eliminate measurement error due to changes in index of refraction.

Further, at least one embodiment of the displacement measurement system may exhibit negligible measurement error due to expansion of the XY stage 60 as the object to be measured, and may also reduce measurement error due to expansion of the optical unit 21 of the detector head 20 owing to temperature compensation of the detector head 20.

In this case, for example, precise temperature compensation up to 0.01° C. may be possible and therefore a displacement depending on temperature may be reduced to 0.5 nm.

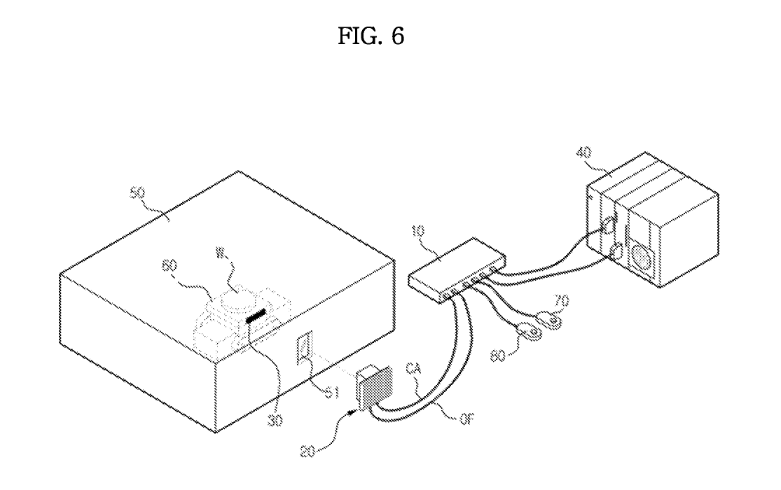

FIG. 6 shows another embodiment of a displacement measurement system which includes a temperature sensor 70 and a humidity sensor 80 as environmental compensation devices.

In this embodiment, the controller 40 may perform temperature compensation of detector head 20 in consideration of temperature and humidity (measurements obtain by sensors 70 and 80) of an environment in which the displacement measurement system is installed. This may allow for a more precise measurement of a displacement relative to the initial position of the XY stage 60.

As is apparent from the above description, according to one embodiment, a detector head of a laser interferometer is provided with a temperature sensor and/or a thermoelectric module to detect a temperature of the detector head and perform temperature compensation based on the detected temperature. This may reduce measurement error due to temperature change of the detector head, thereby achieving highly precise measurement of a displacement of an object to be measured.

According to another embodiment, an object to be measured may be located in a vacuum chamber. This may have the effect of reducing temperature-induced measurement errors caused by changes in index of refraction, expansion of an object to be measured, and/or temperature changes of the detector head.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A temperature control device comprising:
logic configured to receive a signal indicative of a temperature of a light receiver; and
a controller coupled to the signal line and configured to control a temperature of the light receiver based on the temperature signal, the controller configured to generate signals for controlling a heat exchanger having a Peltier region coupled to the light receiver, the signals including a first signal to cause the heat exchanger to remove heat from the light receiver and a second signal to cause the heat exchanger to apply heat to the light receiver.

2. The device of claim 1, wherein:
the first signal causes a control current to flow in a first direction to cause the Peltier region to operate in a manner which causes heat to be removed from the light receiver, and
the second signal causes the control current to flow in a second direction to cause the Peltier region to operate in a manner which causes heat to be applied to the light receiver.

3. The device of claim 1, wherein:
when the temperature signal is above a reference temperature, the controller is configured to generate the first signal to cause the heat exchanger to remove heat from the light receiver.

4. The device of claim 3, wherein:
when the temperature signal is below a reference temperature, the controller is configured to generate the second signal to cause the heat exchanger to apply heat to the light receiver.

5. The device of claim 1, wherein the controller is configured to set a magnitude of the first signal or the second signal based on the temperature signal.

6. The device of claim 5, wherein the magnitude of the first signal or the second signal corresponds to temperature change of the light receiver to be performed by the heat exchanger.

7. An optical device comprising:
a light receiver configured to receive light; and
a heat exchanger coupled to the light receiver and including a Peltier region between a cold sink and a heat sink, the Peltier region configured to receive a first signal to cause heat to be removed from the light receiver and a second signal to cause heat to be applied to the light receiver.

8. The optical device of claim 7, wherein:
the first signal causes a temperature of the light receiver to decrease to within a temperature range, and
the second signal causes the temperature of the light receiver raise to increase to within the temperature range.

9. The optical device of claim 7, further comprising:
a sensor configured to detect a temperature of a light receiver,
wherein the Peltier region receives the first and second control signals based on the temperature detected by the sensor.

10. The optical device of claim 7, wherein the Peltier region is in direct contact with the cold sink and the heat sink.

11. The optical device of claim 7, wherein:
the cold sink at least partially surrounds the light receiver, and
the heat sink is adjacent the cold sink.

12. A measurement device comprising:
a light source;
a reflector coupled to a test object;
a light detector between the light source and reflector; and
a controller configured to measure a position of the test object based on an interference pattern generated by a reference beam and a measurement beam output from the light detector, the measurement beam traveling along an optical path that includes the reflector, and wherein:
the controller is configured to control a temperature of the light detector by generating signals for a heat exchanger having a Peltier region coupled to the light detector, the signals including a first signal to cause the heat exchanger to remove heat from the light receiver and a second signal to cause the heat exchanger to apply heat to the light receiver.

13. The device of claim 12, wherein:
the first signal causes a control current to flow in a first direction to cause the Peltier region to operate in a manner which causes heat to be removed from the light receiver, and
the second signal causes the control current to flow in a second direction to cause the Peltier region to operate in a manner which causes heat to be applied to the light receiver.

14. The device of claim 12, wherein the controller is configured to generate the first signal when a temperature detected by a sensor is above a reference temperature and is configured to generate the second signal when the temperature detected by the sensor is below the reference temperature.

15. The device of claim 14, wherein the controller is configured to set a magnitude of the first signal or the second signal based on the temperature detected by the sensor.

16. The device of claim 15, wherein the magnitude of the first signal or the second signal corresponds to temperature change of the light receiver to be performed by the heat exchanger.

17. The device of claim 12, wherein the heat exchanger includes:
a cold sink at least partially around the light detector, and
a heat sink is adjacent the cold sink, wherein the Peltier region is between the heat sink and the cold sink.

18. The device of claim 12, wherein the test object is a stage supporting a semiconductor wafer.

19. The device of claim 12, wherein at least the reflector and the light detector are located in a vacuum chamber.

20. The device of claim 12, wherein the light detector includes:
a beam splitter through which passes the reference beam, the measurement beam, and a beam from the light source; and
a reflector to receive the reference beam from the beam splitter and to reflect the reference beam back to the beam splitter.
